(19) United States
(12) Patent Application Publication
(10) Pub. No.: US 2007/0053331 A1
(43) Pub. Date: Mar. 8, 2007

(54) QOS-aware radio resource management (for wireless communication) with activity detection

(76) Inventors: Troels E. Kolding, Klarup (DK); Klaus I. Pedersen, Aalborg (DK)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/220,892

(22) Filed: Sep. 6, 2005

(51) Int. Cl. H04Q 7/24

(52) U.S. Cl. 370/338; 370/230; 455/453

(57) ABSTRACT

A packet scheduler (21) that schedules packets for wireless transmission to a UE (16) during a time interval, based on calculating a metric for the UE (16) that takes into account both an activity ratio indicative of the long-term required throughput (if any) for the UE (16) compared to a scheduled throughput. The packet scheduler (21) compares the metric for the UE with that it calculates for other UE's also having packets to be scheduled for delivery during the time interval, and the packets of the UE for which the metric is greatest are scheduled preferentially.

### BACKGROUND OF THE INVENTION

1. Technical Field

The present invention pertains to the field of telecommunications. More particularly, the present invention pertains to so-called packet scheduling in a wireless communication system, i.e. the tasks of arranging in order packets for downlink to user equipment and allocating radio resources for use in transmitting the packets to the user equipment.

2. Discussion of Related Art

UMTS (Universal Mobile Telecommunications Service) offers both circuit-switched and packet-switched access to telecommunications services via a radio access network, called a UTRAN (UMTS terrestrial radio access network). Like any wireless communication system, UMTS includes a radio access network (a UTRAN) and a core network, which is then coupled to other communication networks, including, e.g. the Internet.

A UTRAN uses WCDMA (wideband code division multiple access) over an air interface to communicatively couple to a UE (user equipment, i.e. a wireless terminal such as a mobile station or other equipment including means for communicating with a radio access network or service access point of a telecommunication system), and includes one or more RNC's (radio network controllers) each controlling one or more Node-B's, i.e. equipment used to provide the air interface with the UE, corresponding in some respects to a base transceiver station of GSM (Global System for Mobile communications). In case of UMTS, packet scheduling is the process by which an RNC or a Node-B determines how and when to transmit packets to the UE's to which it is communicatively coupled. (A Node-B makes packet scheduling decisions for packets intended for UE's in its zone of coverage, whereas an RNC makes packet scheduling decisions for packets intended for all UE's in all the zones of the Node-B's controlled by the RNC.)

In a UTRAN, for ordinary packet access, scheduling is performed by the RNC. For what is called HSDPA (high speed downlink packet access), at least some of the packet scheduling is performed by a Node-B.

Most other wireless communication systems, e.g. GSM including a GPRS (General Packet Radio Service), also provide packet access, i.e. a communication service for bursty data, in a form generally indicated as packets, so that a UE and a server (e.g. a server attached to the Internet) can exchange data in the form of packets.

In GSM, packets are communicated using only dedicated channels.

In UMTS/WCDMA, packet data is communicated on common channels in addition to dedicated channels. In providing packet scheduling, an UMTS/WCDMA packet scheduler assigns different codes and/or different time slots for communicating packets to a UE. In UMTS/WCDMA, UE's may share the same code and/or time slots as other UE's for receiving packets (and also for sending packets), or they may be assigned a dedicated resource, e.g. a particular code channel or one or more particular time slots. In case of a shared channel, for example, a single code may he assigned to several UEs, with each sharing the corresponding code channel via time division, i.e. each having an assigned time slot (or time slots) in a radio frame. A common channel is similar in that respect to a shared channel. There are typically several common packet channels per cell, each having a different data rate.

In case of UMTS/WCDMA, a packet scheduler must decide what channel to use to transmit packets to the UE's for which it is scheduling, and also the power and data rate to use for the packets. All of these—the channels, the power available, and the data rates—are finite resources that must be partitioned among the UE's requesting packet access service.

One factor that must often be taken into account by a packet scheduler is the possibility of different QoS requirements for the packets of different users. A parameter indicating a required QoS for a UE can—in some wireless communication systems—be provided to the Node-B/RNC by the core network as a result of the UE having subscribed to a class of service. The other factors all have to do with the quality of the radio link to the UE, which generally degrades with distance, and can also be affected by sources of noise or other interference and also multipath. Further, the link can be highly variable because the UE can move during a communication session from a location where the link is strong, to a location where the link is poor (because of more noise or other interference, including possibly more multipath). An HSDPA UE periodically sends a Channel Quality Indicator (CQI) to the serving Node-B indicating what data rate (and using what coding and modulation schemes and number of multicodes) the UE can support under its current radio conditions.

There are a number of scheduling strategies typically used for partitioning the capacity of a Node-B to deliver packets to UE's in its zone of coverage. Common among these, whether for a shared channel or a dedicated channel, are so-called fair throughput (which aims to give all users the same throughput), fair time (which provides all users with the same resources of time and power), and C/I scheduling (which allocates all resources to the UE having packets still to be delivered and having the strongest link). For a dedicated channel, a fair time scheduler is sometimes called a round-robin scheduler: UE's are served in sequential order so they all get the same average allocation time.

There are some packet schedulers that take into account QoS requirements and also instantaneous channel conditions. A packet scheduler typically calculates a value for a scheduling metric in arriving at scheduling decisions. The schedulers that take into account QoS requirements and also instantaneous channel conditions often include the QoS requirements directly in the scheduling metric, and then arrive at a scheduling decision in an iteration process converging in the scheduling decision, a decision that ideally meets the QoS requirements of all the UE's being served. In a system where UE's may have different fading patterns and where buffers in the Node-B (or RNC) may be on or off, such iteration may take an undesirable amount of time before the packet scheduler determines whether all the QoS requirements can be met.

What is needed is a way by which a packet scheduler can more rapidly arrive at a scheduling decision that takes into account possibly different QoS requirements for the different UE's for whom packet delivery is being scheduled, as well as the different channel conditions for the different UE's. Ideally, the output of the packet scheduler can be advantageously used in admission and load control, to adjust the radio resources of the radio access network, and to discard the most costly UE's (in terms of radio resources of the radio access network).

### DISCLOSURE OF INVENTION

Accordingly, in a first aspect of the invention, a method is provided, comprising: a step in which an element of a radio access network determines for a given time interval a respective activity ratio for each wireless terminal in communication with the radio access network and having packets to be delivered to the wireless terminal by the radio access network in the given time interval; and a step in which the element of the radio access network determines for the given time interval a respective metric for each wireless terminal, for use in scheduling the packets for delivery to the wireless terminal, wherein the metric for each wireless terminal is based at least in part on the activity ratio for the wireless terminal; wherein the activity ratio for each of the wireless terminals having packets to be delivered during the given time interval is a ratio of a long-term throughput required for the wireless terminal averaged over time intervals when the wireless terminal has packets to be delivered to the wireless terminal, divided by a scheduled throughput for the wireless terminal indicating throughput experienced by the wireless terminal in the given time interval.

In accord with the first aspect of the invention, in the step of determining a metric for each wireless terminal, a scaling factor may be determined for the wireless terminal based on the activity ratio for the wireless terminal, and the scaling factor may be used to adjust by multiplication a metric for the wireless terminal according to a scheduling algorithm not taking into account the activity ratio for the wireless terminal. Further, the scheduling algorithm not taking into account the activity ratio for the wireless terminal may use as a metric for a wireless terminal in the given time interval a ratio of instantaneous supported rate to average delivered throughput, and may calculate the average delivered throughput using a recursion relation including a user-dependent convergence-controlling parameter. The scheduling algorithm not taking into account the activity ratio for the wireless terminal may be for example a proportional fair packet scheduling algorithm.

In a second aspect of the invention, a computer program product is provided, comprising a computer readable storage structure embodying computer program code thereon for execution by a computer processor, wherein said computer program code comprises instructions for performing the steps of a method according to the first aspect of the invention.

In a third aspect of the invention, an application specific integrated circuit is provided, comprising electronic components arranged and inter-connected as an integrated circuit and so as to perform the steps of a method according to the first aspect of the invention.

In a fourth aspect of the invention, an apparatus is provided, comprising: means for performing the steps of a method according to the first aspect of the invention.

In accord with the fourth aspect of the invention, the apparatus may be a component of a terminal used for wirelessly communicating packets to a wireless terminal.

The invention also provides a terminal of a radio access network for wirelessly communicating packets to a wireless terminal of a user is provided, comprising an apparatus according to the fourth aspect of the invention.

Also in accord with the fourth aspect of the invention, the apparatus may be a component of a controller of one or more terminals for communicating packets by wireless transmission.

The invention also provides a controller of a radio access network for controlling one or more terminals used for wirelessly communicating packets to a wireless terminal of users, comprising an apparatus according to the fourth aspect of the invention.

The invention also provides a telecommunications system, comprising a core network coupled to at least one element of at least one other telecommunications system, a radio access network coupled to the core network and including an apparatus according to the fourth aspect of the invention, and a plurality of wireless terminals adapted for communicatively coupling to the radio access network.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram of a radio access network and packet-switching portion of a wireless communication system, and in particular a UTRAN and a SGSN of a core network of an UMTS, with the UTRAN in radio communication with two UE's.

FIG. 2 is a block diagram/flow diagram of selected components of a Node-B in the UTRAN of FIG. 1, responsible for packet scheduling and admission and load control, and including in addition an activity detector, according to the invention.

### BEST MODE FOR CARRYING OUT THE INVENTION

The invention is here described as providing methods and equipment for use with a UTRAN, but it should be understood that the invention is of use in any kind of wireless communication system providing packet access, i.e. providing packets to UE's communicatively coupled to the wireless communication system. Also, the invention is illustrated using a so-called proportional fair packet scheduling algorithm (which is modified by the invention as described below to take into account the scheduled throughput for a QoS user compared to the throughput required by the QoS for the user), but it should be understood that the invention is at least of use for modifying any QoS-aware packet scheduling algorithm.

The invention provides, in case of a UTRAN, a Node-B in which packet scheduling decisions for transmitting packets to UEs in wireless communication with the Node-B, are made taking into account channel conditions of the users/UE's. The invention can also provide a RNC performing packet scheduling decisions in the same way, but doing so for all the UE's connected to all the Node-B's controlled by the RNC. Typically, the packet scheduling function is located in a Node-B for HSDPA, but in an RNC otherwise.

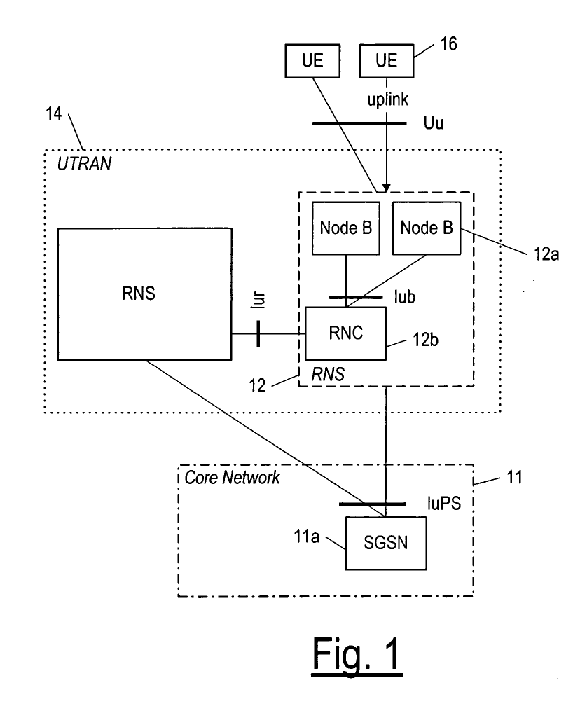

Referring now to FIG. 1, such a Node-B 12a is shown as one Node-B among others controlled by a RNC 12b (via typically wireline connections) and in communication with a UE 16 (as well as possibly other UEs) via wireless communication. The RNC and the various Node-B's constitute a Radio Network System (RNS) 12. A UTRAN 14 is constituted by the RNS 12 as well as possibly other RNS's. The one or more possible RNS's interface with a core network 11, and in particular, with a serving GPRS support node (SGSN) 11a of the core network.

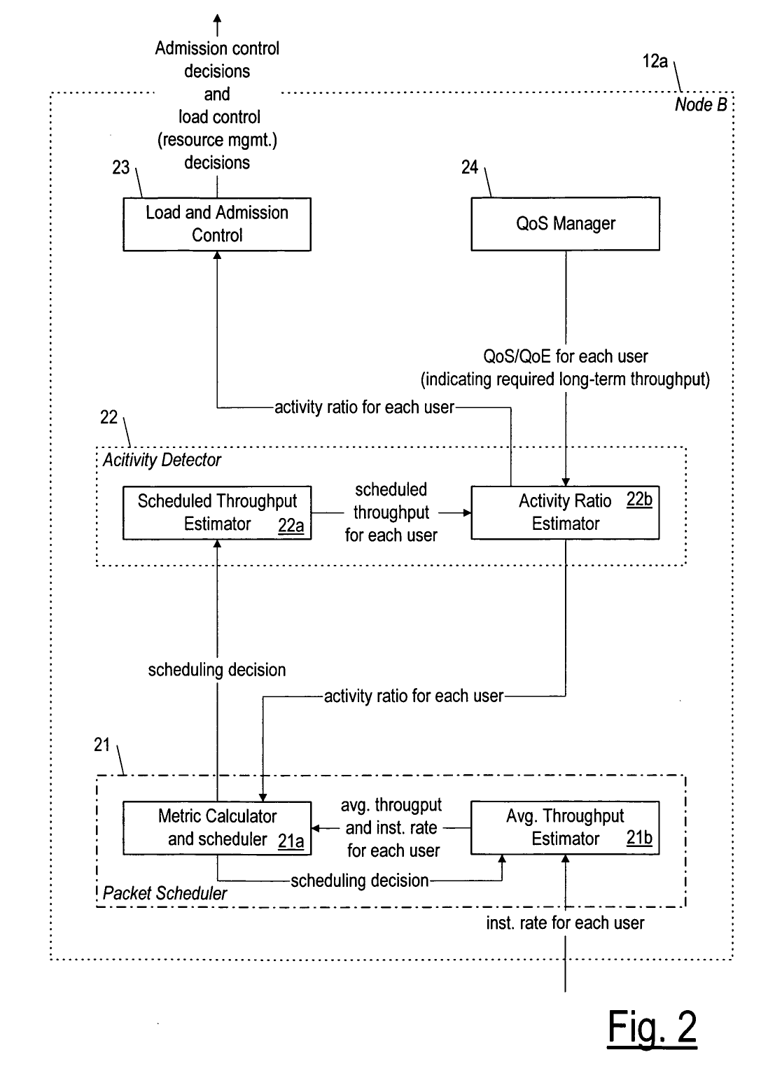

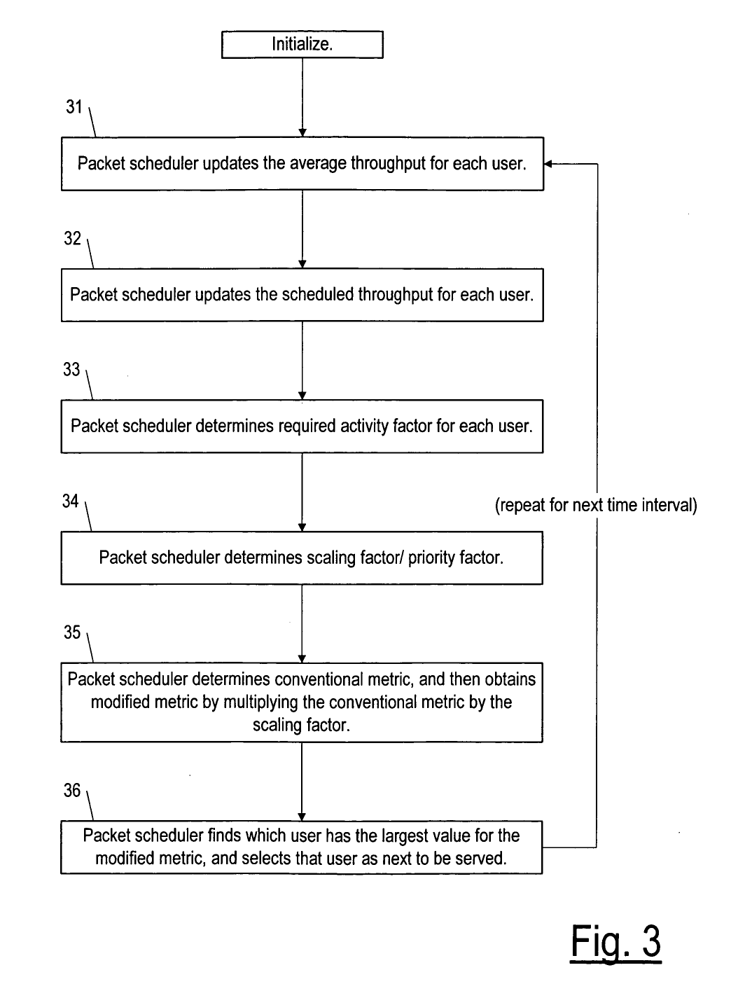

Referring now to FIG. 2, components of the Node-B 12a of particular relevance to the invention are shown, according to one embodiment of the invention. The Node-B manages radio resource, i.e. it includes radio resource management functionality by which it allocates more or less power or time or data rate for transmitting packets to each of the different UE's in its zone of coverage, so at to achieve a goal such as optimizing total throughput given one or more constraints, constraints such as providing a required quality of service to one or more of the UE's in its zone. The components shown in FIG. 2 are the key parts of the radio resource management functionality related to admission control, load control, and packet scheduling. Other components, known in the art, are not shown. The modular arrangement of the components of the Node-B 12a shown in FIG. 1 is not intended to be limiting. Other architectures besides the arrangement shown are possible, as would be clear to one skilled in the art of wireless communication.

In performing the task of radio resource management, the Node-B 12a makes what are called scheduling decisions, i.e. the Node-B schedules packets for transmission to the UE's using the radio resources available to the Node-B. The RNC, and in some cases the core network, reserves the radio resources available to the Node-B.

According to the embodiment of the invention shown in FIG. 2, the Node-B 12a, and in particular its radio resource management functionality, includes a packet scheduler 21 for scheduling the transmission of packets destined for the UE's in its zone of coverage. The packet scheduler includes a metric calculator and scheduler 21a, which calculates a value for a metric for each UE, and then makes the packet scheduling decisions using the metrics (i.e. selecting the UE having the largest metric as the UE to be served first, or else at least to be served preferentially, and so on). To calculate a value for the metric for each UE, the metric calculator uses an estimate of the average throughput for the user (for the subject time interval) and the instantaneous supported rate for the UE (for the time interval), provided by an average throughput estimator module 21b (only the average throughput is estimated, based at least in part on the instantaneous rate, which is an input to the average throughput estimator module 21b). The average throughput for a UE is an average only over the time when data for the UE is actually buffered in the Node-B for delivery to the UE.

The packet scheduler 21 provides the scheduling decisions to an activity detector 22. The activity detector includes a scheduled throughput estimator 22a, which estimates what is called here the scheduled throughput for each user, i.e. the throughput when the user is actually scheduled (i.e. when packets for are scheduled for delivery to the user).

The scheduled throughputs (one for each user) are used by an activity ratio estimator 22b, another component of the activity detector 22, along with the QoS/QoE (Quality of Service/Quality of Experience) requirements for each user, to predict (what should be) the activity ratio for the user, i.e. e.g. the number of frames scheduled for the user compared to the number of frames in total during the session time for the user in order for the user to receive the QoS appropriate for the user (i.e. an adequate QoS, such as a subscribed-to QoS), although any measure of the time of activity for the user compared to the total time during which the Node-B is communicating packets to the UE could be used as an activity ratio. (A UE may request or subscribe to a high QoS, or may not request any particular QoS, in which case the UE is given the best possible QoS taking all requested or subscribed QoS's into account.)

The activity ratios are provided by the activity ratio estimator 22b both to the packet scheduler 21 as noted above, and also to a load and admission control module 23, for use in providing QoS-aware load and admission control. The load and admission control module 23, using the activity ratios required for each user to received adequate QoS, then allocates more or less scheduling resources to each user, stops or allows admission of new users, and/or start to remove user from the queue (in the Node-B) of UE's having packets waiting to be scheduled (for transmission to the respective users).

In an illustrative embodiment of the invention, the packet scheduler 21 is a modified proportional fair packet scheduler (modified per the invention), and the activity detector 22 is implemented as a recursive filter with a fast adaptation interval. Hence, when priorities shift between users, or when users come into the system with different radio channel behavior—e.g. significant velocity leading to highly variable fading, multi-path delay, etc.—the system quickly reassesses the impact of the changed user requirements and channel conditions on the required activity for each user.

As mentioned, the packet scheduler uses a metric to arrive at scheduling decisions. There is a metric value for each user, for each time interval during which packets are to be transmitted to the UE's. In a conventional proportional fair packet scheduling algorithm, the metric for user k in time interval n (e.g. a transmission time interval), is

$${M}_{k}^{′} [ n ] = \frac{{r}_{k} [ n ]}{{T}_{k} [ n ]} \qquad ( 1 )$$

where rₖ[n] is the instantaneous supported rate for user k in time interval n, and Tₖ[n] is the average delivered throughput (for user k in time interval n), calculated (recursively) using:

$${T}_{k} [ n ] = ( 1 - \{ {B}_{k} [ n ] > 0 \} \cdot \frac{1}{{N}_{k}} ) {T}_{k} [ n - 1 ] + \frac{{λ}_{k} [ n ]}{{N}_{k}} {r}_{k} [ n ] , \qquad ( 2 )$$

in which λₖ[n] is an activity factor having a value of one if user k is scheduled in n, and zero otherwise, Bₖ[n] is the available bits in the buffer for user k in time interval n, {Bₖ[n]>0} is a boolean expression and is of value 1 if true, and 0 if false, and Nₖ is a user-dependent convergence-controlling parameter and represents the memory of the filter (exponential decay).

The value for the instantaneous supported data rate for each user rₖ[n] is estimated—e.g. in WCDMA/HSDPA but also in other wireless communication systems—at the receiver (i.e. at the UE) and signaled to the Node-B as such, i.e. as a value for the instantaneous supported data rate for each user rₖ[n]. In other wireless communication systems there are similar mechanisms, although sometimes the reported measure is a signal-to-interference level rather than an instantaneous supported data rate, but a mapping between the two is then performed by the packet scheduler. Sometimes even in WCDMA without HSDPA, and where the Node-B provides packets over a shared downlink channel, instead of the UE signaling a value for rₖ[n], link quality for communications with the UE on other than the shared packet downlink channel can be used by the packet scheduler to predict performance on the shared packet downlink channel, and the performance can then be mapped or correlated with a value for rₖ[n].

Nₖ is a dimensionless constant that makes the proportional fair packet scheduling algorithm either (1) converge faster with lesser accuracy, or (2) converge slower with very high accuracy. In general, the optimum value for Nₖ (which can be set e.g. by the manufacturer, operator, or dynamically, according to some other algorithm) depends on the traffic profile for the user and the number of users in the system. Hence, in general Nₖ is, according to findings by the inventors, optimally different for every user in the system, and hence the subscript k denoting a particular user. Reasonable values appear to be in the range of 200-700.

Now in the illustrative embodiment using a conventional proportional fair packet scheduler modified according to the invention, the conventional metric Mₖ′[n] is scaled by a user-specific scaling factor aₖ[n], to arrive at a modified metric,
Mₖ[n]=aₖ[n]·Mₖ′[n]. (3)
The user-specific scaling factor aₖ[n] can be thought of as a priority factor.

The scaling factor aₖ[n] is calculated as follows. First, the above-mentioned activity ratio, denoted âₖ[n], is calculated, using:

$${\hat{α}}_{k} [ n ] = \frac{{T}_{req , k}}{{T}_{sch , k} [ n ]} \qquad ( 4 )$$

where: T_{req,k} is the required throughput for user k (and shown as provided to the activity ratio estimator 22b by the QoS manager 24 of FIG. 2), i.e. the long-term throughput requirement as a guaranteed data rate when the scheduling entity (e.g. a Node-B) has data buffered for user k; and T_{sch,k}[n] is what is here called the scheduled throughput, and is the throughput for user k during the time when use k is actually scheduled. T_{req,k} is known to the packet scheduler. T_{sch,k}[n] is calculated (also recursively, like Tₖ[n], i.e. as a recursive filter) using:

$${T}_{sch , k} [ n ] = ( 1 - \frac{{λ}_{k} [ n ]}{{N}_{s}} ) {T}_{sch , k} [ n - 1 ] + \frac{{λ}_{k} [ n ]}{{N}_{s}} {r}_{k} [ n ] , \qquad ( 5 )$$

where Nₛ is a user-independent convergence-controlling parameter replacing Nₖ and represents the effective distribution between the UE's, and is typically smaller than Nₖ (for any k ). Nₛ is in many ways similar to Nₖ except that it relates to the second tier filter and the inventors have found that it is advantageously the same for all users (since it is trying to predict the overall user diversity and activity factor for a user, but considering the scheduling of all other users). It is also dimensionless and it seems from studies by the inventors that the performance of the scheduler does not depend much on its setting, but that advantageous settings are for values in the range of 20-80.

With the activity ratio âₖ[n] calculated as in eq. (3), the metric scaling factor/priority factor aₖ[n] is assigned a value as follows (in the metric calculator and scheduler module 21a of FIG. 2):

If

$${\sum }_{k} {\hat{α}}_{k} [ n ] = 1 ,$$

(required capacity is same as available) then
aₖ[n]=âₖ[n] for all k (6)
in which case all available capacity is allocated to the QoS-users so that the “best-effort” users (i.e. those not having any required QoS) get no capacity.

If

$${\sum }_{k} {\hat{α}}_{k} [ n ] > 1 ,$$

(required capacity is more than available) then

$$\begin{matrix}{α}_{k} [ n ] = \frac{{\hat{α}}_{k} [ n ]}{{\sum }_{k} {\hat{α}}_{k} [ n ]} & for all k\end{matrix} \qquad ( 7 )$$

so that each user suffers the same reduction of service, i.e. the service of each user is reduced by the same factor

$$\frac{1}{{\sum }_{k} {\hat{α}}_{k} [ n ]} .$$

If

$${\sum }_{k} {\hat{α}}_{k} [ n ] < 1 ,$$

(there is excess capacity) then
aₖ[n]=âₖ[n] for each k for which âₖ[n]>0 (8)
and

$$\begin{matrix}{α}_{k} [ n ] = \frac{1 - {\sum }_{k} {\hat{α}}_{k} [ n ]}{{N}_{nonQoS}} & for all other k ,\end{matrix} \qquad ( 9 )$$

where N_{nonQos} is the number of users having no required QoS (i.e. best-effort users, or in other words users for which âₖ[n]=0) so that all QoS users (i.e. users for which âₖ[n]>0) get the same scaling factor as in the case of required capacity equal to available capacity, but the non QoS users get some capacity too, the same for each, as given by eq. (9).

Having so calculated the scaling factor aₖ[n] and the conventional metric Mₖ′[n], the metric Mₖ[n]=aₖ[n]·Mₖ[n] can be calculated (by the metric calculator and scheduler 21a). The packet scheduler then selects the user having the largest modified metric Mₖ[n] value as the next user to receive packets.

Note that in initializing for packet scheduling according to the invention, T_{sch,k} is set to rₖ[n] , and Tₖ[n] is set to rₖ[n]/k.

Thus, and now referring to FIG. 3, the above procedure is shown as including (after initializing) a first step 31 in which the packet scheduler/metric calculator updates the average throughput Tₖ[n] (for each user k). In a next step 32 the scheduled throughput T_{sch,k}[n] is updated. In a next step 33 the required activity factor âₖ[n] is determined, and then in a next step 34 the scaling factor/priority factor aₖ[n] is assigned a value. Finally, in a next step 35 the modified scheduling metric Mₖ[n] is determined (possible at this stage since Tₖ[n] has been updated, and rₖ[n] is known), and then in a last step 36 the user having the largest value for the scheduling metric is selected as next to be served.

The functionality described above as provided by the invention could be implemented as software modules stored in a non-volatile memory of a Node-B or RNC, and executed as needed by copying all or part of the software into executable RAM (random access memory). Alternatively, the logic provided by such software can also be provided by an ASIC (application specific integrated circuit).

The invention has been described in terms of modules of an apparatus and also steps of a method. In addition, the invention encompasses a computer program product including a computer readable storage structure embodying computer program code—i.e. software or firmware—thereon for execution by a computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a step in which an element of a radio access network determines for a given time interval a respective activity ratio for each wireless terminal in communication with the radio access network and having packets to be delivered to the wireless terminal by the radio access network in the given time interval; and
a step in which the element of the radio access network determines for the given time interval a respective metric for each wireless terminal, for use in scheduling the packets for delivery to the wireless terminal, wherein the metric for each wireless terminal is based at least in part on the activity ratio for the wireless terminal;
wherein the activity ratio for each of the wireless terminals having packets to be delivered during the given time interval is a ratio of a long-term throughput required for the wireless terminal averaged over time intervals when the wireless terminal has packets to be delivered to the wireless terminal, divided by a scheduled throughput for the wireless terminal indicating throughput experienced by the wireless terminal in the given time interval.

2. A method as in claim 1, wherein in the step of determining a metric for each wireless terminal, a scaling factor is determined for the wireless terminal based on the activity ratio for the wireless terminal, and the scaling factor is used to adjust by multiplication a metric for the wireless terminal according to a scheduling algorithm not taking into account the activity ratio for the wireless terminal.

3. A method as in claim 2, wherein the scheduling algorithm not taking into account the activity ratio for the wireless terminal uses as a metric for a wireless terminal in the given time interval a ratio of instantaneous supported rate to average delivered throughput, and calculates the average delivered throughput using a recursion relation including a user-dependent convergence-controlling parameter.

4. A method as in claim 3, wherein the scheduling algorithm not taking into account the activity ratio for the wireless terminal is a proportional fair packet scheduling algorithm.

5. A computer program product comprising a computer readable storage structure embodying computer program code thereon for execution by a computer processor, wherein said computer program code comprises instructions for performing the steps of a method according to claim 1.

6. An application specific integrated circuit, comprising electronic components arranged and inter-connected as an integrated circuit and so as to perform the steps of a method according to claim 1.

7. An apparatus, comprising:
means by which an element of a radio access network determines for a given time interval a respective activity ratio for each wireless terminal in communication with the radio access network and having packets to be delivered to the wireless terminal by the radio access network in the given time interval; and
means by which the element of the radio access network determines for the given time interval a respective metric for each wireless terminal, for use in scheduling the packets for delivery to the wireless terminal, wherein the metric for each wireless terminal is based at least in part on the activity ratio for the wireless terminal;
wherein the activity ratio for each of the wireless terminals having packets to be delivered during the given time interval is a ratio of a long-term throughput required for the wireless terminal averaged over time intervals when the wireless terminal has packets to be delivered to the wireless terminal, divided by a scheduled throughput for the wireless terminal indicating throughput experienced by the wireless terminal in the given time interval.

8. An apparatus as in claim 7, wherein the means for determining a metric for each wireless terminal determines a scaling factor for the wireless terminal based on the activity ratio for the wireless terminal, and uses the scaling factor to adjust by multiplication a metric for the wireless terminal according to a scheduling algorithm not taking into account the activity ratio for the wireless terminal.

9. An apparatus as in claim 8, wherein the scheduling algorithm not taking into account the activity ratio for the wireless terminal uses as a metric for a wireless terminal in the given time interval a ratio of instantaneous supported rate to average delivered throughput, and calculates the average delivered throughput using to a recursion relation including a user-dependent convergence-controlling parameter.

10. An apparatus as in claim 9, wherein the scheduling algorithm not taking into account the activity ratio for the wireless terminal is a proportional fair packet scheduling algorithm.

11. An apparatus as in claim 7, wherein the apparatus is a component of a terminal used for wirelessly communicating packets to a wireless terminal.

12. A terminal of a radio access network for wirelessly communicating packets to a wireless terminal of a user, comprising an apparatus as in claim 7.

13. An apparatus as in claim 7, wherein the apparatus is a component of a controller of one or more terminals for communicating packets by wireless transmission.

14. A controller of a radio access network for controlling one or more terminals used for wirelessly communicating packets to a wireless terminal of users, comprising an apparatus as in claim 7.

15. A telecommunications system, comprising a core network coupled to at least one element of at least one other telecommunications system, a radio access network coupled to the core network and including an apparatus as in claim 7, and a plurality of wireless terminals adapted for communicatively coupling to the radio access network.
